(19) United States
(12) Patent Application Publication
(10) Pub. No.: US 2009/0028507 A1
(43) Pub. Date: Jan. 29, 2009

(54) Fiber optic adapter with integrated shutter

(76) Inventors: Ashley Wesley Jones, Denton, TX (US); Daniel Leyva, JR., Arlington, TX (US); Ronald Lee Mudd, Coppell, TX (US); Louis Edward Parkman, III, Richland Hills, TX (US); Peter Timothy Travis, Denton, TX (US)

Correspondence Address: CORNING INCORPORATED, INTELLECTUAL PROPERTY DEPARTMENT, SP-TI-3-1, CORNING, NY, 14831, US

(21) Appl. No.: 11/881,657

(22) Filed: Jul. 27, 2007

(51) Int. Cl. G02B 6/38

(52) U.S. Cl. 385/56

(57) ABSTRACT

The present invention relates generally to fiber optic connectors and adapters, and more specifically to a simplified fiber optic adapter assembly and integrated shutter mechanism. In various embodiments, the simplified fiber optic adapter assembly includes a one-piece outer housing, a one or two-piece inner housing, and several different clip arrangements, reducing the number of parts associated with conventional fiber optic adapter assemblies and eliminating the need for ultrasonic welding or the like. In various embodiments, the integrated shutter mechanism includes one or more shutter doors that are opened internally via the motion required for connector installation.

### BACKGROUND OF THE INVENTION

1. Field of the Invention

The present invention relates generally to fiber optic connectors and adapters, and more specifically to a simplified fiber optic adapter assembly and integrated shutter mechanism. In various embodiments, the simplified fiber optic adapter assembly includes a one-piece outer housing, a one or two-piece inner housing, and several different clip arrangements, reducing the number of parts associated with conventional fiber optic adapter assemblies and eliminating the need for ultrasonic welding or the like. In various embodiments, the integrated shutter mechanism includes one or more shutter doors that open internally via the motion required for connector installation.

2. Technical Background of the Invention

In various applications, it is desirable to connect and disconnect fiber optic cables from various sources. A pair of fiber optic cables may be coaxially aligned and optically coupled using a pair of SC connectors and an SC adapter, a pair of MU connectors and an MU adapter, or the like. These push/pull adapters have a pair of openings, one at each end of the adapter, each of the openings configured to receive a corresponding connectorized fiber optic cable. Typically, the adapters are fixed to a dividing member, such as a planar surface, or the like.

Referring to FIG. 1, one type of conventional adapter 10 consists of a pair of outer housings 12, a pair of inner housings 14, a sleeve 16, a retention clip 18, and a pair of dust caps 20, for a total of eight parts. Typically, the sleeve 16 is disposed partially within each of the inner housings 14, which are captured within the outer housings 12 when they are joined and ultrasonically welded together or the like. The adapter 10 is thus configured to coaxially receive a pair of conventional connectors (not illustrated), one at each end of the adapter 10. The pair of ferrules (not illustrated) associated with the connectors are optically coupled within the sleeve 16. Preferably, the outer housings 12 collectively define a pair of exterior tabs 22a, 22b, 24a, and 24b that selectively work in cooperation with a pair of retention tabs 26a and 26b manufactured into opposing sides of the retention clip 18, which is typically made of a metal, metal alloy, or the like. When the adapter 10 is installed in a dividing member (not illustrated), the planar surface abuts the exterior tabs 22a, 22b, 24a, and 24b of the outer housings 12 on one side and the retention tabs 26a and 26b of the retention clip 18, which selectively engages a recess 19 manufactured into one of the outer housings 12, on the other side. The dust caps 20 are selectively disposed within each end of the adapter 10 in order to prevent the intrusion of particulate matter into the interior of the adapter 10 when the connectors are not engaged. Such an adapter 10 is known to those of ordinary skill in the art.

Referring to FIG. 2, another type of conventional adapter 30 consists of the pair of outer housings 12, the pair of inner housings 14, the sleeve 16, and the pair of dust caps 20, for a total of seven parts. Again, the sleeve 16 is disposed partially within each of the inner housings 14, which are captured within the outer housings 12 when they are joined and ultrasonically welded together or the like. The adapter 30 is thus configured to coaxially receive the pair of conventional connectors (not illustrated), one at each end of the adapter 30. The pair of ferrules (not illustrated) associated with the connectors are optically coupled within the sleeve 16. Preferably, the outer housings 12 collectively define the pair of exterior tabs 22a, 22b, 24a, and 24b that, in this case, selectively work in cooperation with a pair of retention tabs 28 manufactured into opposing sides of one of the outer housings 12. When the adapter 30 is installed in the dividing member (not illustrated), the planar surface abuts the exterior tabs 22a, 22b, 24a, and 24b of the outer housings 12 on one side and the retention tabs 28 of one of the outer housings 12 on the other side. The dust caps 20 are selectively disposed within each end of the adapter 30 in order to prevent the intrusion of particulate matter into the interior of the adapter 30 when the connectors are not engaged. Again, such an adapter 30 is known to those of ordinary skill in the art.

Referring to FIG. 3, a further type of conventional adapter 40 consists of the pair of outer housings 12, an integrated/combination inner housing and sleeve assembly 32, the retention clip 18, and the pair of dust caps 20, for a total of six parts. Typically, the integrated inner housing and sleeve assembly 32 includes a ceramic or non-ceramic internal sleeve portion (not illustrated) and is captured within the outer housings 12 when they are joined and ultrasonically welded together or the like. The adapter 40 is thus configured to coaxially receive the pair of conventional connectors (not illustrated), one at each end of the adapter 40. The pair of ferrules (not illustrated) associated with the connectors are optically coupled within the internal sleeve portion of the integrated inner housing and sleeve assembly 32. Preferably, the outer housings 12 collectively define the pair of exterior tabs 22a, 22b, 24a, and 24b that selectively work in cooperation with the pair of retention tabs 26a and 26b manufactured into opposing sides of the retention clip 18, which is typically made of a metal, metal alloy, or the like. When the adapter 40 is installed in the dividing member (not illustrated), the planar surface abuts the exterior tabs 22a, 22b, 24a, and 24b of the outer housings 12 on one side and the retention tabs 26a and 26b of the retention clip 18, which selectively engages the recess 19 manufactured into one of the outer housings 12, on the other side. The dust caps 20 are selectively disposed within each end of the adapter 40 in order to prevent the intrusion of particulate matter into the interior of the adapter 40 when the connectors are not engaged. Again, such an adapter 40 is known to those of ordinary skill in the art.

Disadvantageously, conventional adapters consist of a substantial number of parts, some of which must be ultrasonically welded or the like. This results in increased component costs, increased labor requirements, increased training requirements, and decreased efficiencies. Thus, what are needed in the art are improved adapters that consist of a reduced number of parts, none of which must be ultrasonically welded or the like. Preferably, such improved adapters are realized by utilizing a one-piece outer housing, a one or two-piece inner housing, and several different clip arrangements, among other things.

For various environmental and safety reasons, it may also be desirable to employ a shutter with a fiber optic adapter. This shutter serves the dual purpose of preventing dust from infiltrating the adapter, similar to a dust cap, and providing eye protection from the connected light source. Existing shutter solutions require that the shutter door(s) be opened in an initial operation prior to connector installation. This is cumbersome for the operator/installer. Thus, what is needed in the art is an improved adapter that utilizes one or more internally opening shutter doors, with the shutter door(s) being opened in the same operation as connector installation. What is also needed in the art is an improved adapter that utilizes one or more internally opening shutter doors in a latching geometry that retains a connector within the adapter, while maintaining the clearance necessary for the motion of the shutter door(s), without significantly and undesirably increasing the overall dimensions of the adapter. Such dimensional increase negatively impacts the density of grouped adapters. What is further needed in the art is an improved adapter that utilizes one or more internally (and outwardly) opening shutter doors that does not compromise cleanliness, with a connector dragging across the surface of the shutter door(s) and carrying dust into the connector.

### BRIEF SUMMARY OF THE INVENTION

In various embodiments, the present invention provides a simplified fiber optic adapter assembly that includes a one-piece outer housing, a one or two-piece inner housing, and several different clip arrangements, thereby reducing the number of parts associated with conventional fiber optic adapter assemblies and eliminating the need for ultrasonic welding or the like, thus resulting in decreased component costs, decreased labor requirements, decreased training requirements, and increased efficiencies.

In one embodiment, the present invention provides a simplified fiber optic adapter assembly for optically coupling a plurality of optical fibers, including: an outer housing, the outer housing having an interior portion including a retention structure, wherein the retention structure is one of integrally formed with the outer housing and fixedly attached to the outer housing; an inner housing selectively disposed within the interior portion of the outer housing, the inner housing having an exterior portion including a corresponding retention structure, wherein the corresponding retention structure is one of integrally formed with the inner housing and fixedly attached to the inner housing, the inner housing further having an interior portion defining a bore; and a sleeve at least partially disposed within the bore defined by the interior portion of the inner housing. The outer housing also has an exterior portion including at least one tab structure configured to abut a planar surface through which the outer housing is disposed. Optionally, the exterior portion of the outer housing also includes at least one ramp structure configured to abut the planar surface through which the outer housing is disposed. The inner housing consists of a one or two-piece inner housing. In one embodiment, the retention structure of the outer housing consists of a protruding structure and the corresponding retention structure of the inner housing consists of a recessed structure that is configured to selectively receive the protruding structure. In another embodiment, the retention structure of the outer housing consists of a substantially flexible protruding structure and a stop structure and the corresponding retention structure of the inner housing consists of a tab structure that is configured to be selectively disposed between the substantially flexible protruding structure and the stop structure. In a further embodiment, the retention structure of the outer housing consists of a substantially inflexible protruding structure and a stop structure and the corresponding retention structure of the inner housing consists of a tab structure that is configured to be selectively disposed between the substantially inflexible protruding structure and the stop structure. Preferably, the adapter assembly is free from any ultrasonic or other welds.

In another embodiment, the present invention provides a simplified fiber optic adapter assembly for optically coupling a plurality of optical fibers, including: an outer housing, the outer housing having an interior portion including a retention structure, wherein the retention structure is integrally formed with the outer housing; a one-piece inner housing selectively disposed within the interior portion of the outer housing, the one-piece inner housing having an exterior portion including a corresponding retention structure, wherein the corresponding retention structure is integrally formed with the one-piece inner housing and, the one-piece inner housing further having an interior portion defining a bore; and a sleeve at least partially disposed within the bore defined by the interior portion of the one-piece inner housing. Optionally, the interior portion of the outer housing defines a corresponding bore within which the sleeve is at least partially disposed. The outer housing also has an exterior portion including at least one tab structure configured to abut a planar surface through which the outer housing is disposed. Optionally, the exterior portion of the outer housing also includes at least one ramp structure configured to abut the planar surface through which the outer housing is disposed.

In various embodiments, the present invention also provides a simplified shuttered fiber optic adapter assembly that includes internally opening shutter doors that, when actuated, act as latches for engaging and securing a conventional mating connector. The motion of these shutter doors is initiated by the insertion of the connector. The geometry and orientation of the shutter doors is such that the ferrule of the connector does not make contact with the shutter doors, thus avoiding contamination of the ferrule. The latching geometry utilized retains the connector within the adapter, while maintaining the clearance necessary for the motion of the shutter doors, without significantly and undesirably increasing the overall dimensions of the adapter. For example, the adapter of the present invention does not have to be lengthened relative to a conventional adapter in order to accommodate the motion of the shutter doors. Again, such dimensional increase negatively impacts the density of grouped adapters. Optionally, the shutter doors are manufactured from a translucent material in order to incorporate visual fault locator (VFL) capability, enabling the operator/installer to easily determine if the adapter is receiving a signal. Again, “snap-fit’ assembly is provided, eliminating the need for ultrasonic welding or the like.

In one embodiment, the present invention provides a simplified shuttered fiber optic adapter assembly for optically coupling a plurality of optical fibers, including: an outer housing, one end of the outer housing defining an opening; a pair of shutter doors disposed at the opening defined by the outer housing, each of the pair of shutter doors including a shutter door connector latch mechanism configured to engage and retain a connector that is inserted through the pair of shutter doors, through the opening defined by the outer housing, and into the outer housing; and a connector alignment cap disposed at the opening defined by the outer housing, the connector alignment cap configured to hingedly secure the pair of shutter doors at the opening defined by the outer housing. The shuttered adapter assembly also includes one or more springs disposed at least partially adjacent to the pair of shutter doors, the one or more springs operable for biasing the pair of shutter doors in a closed configuration. Preferably, the shuttered adapter assembly is free from any ultrasonic or other welds. Optionally, the shuttered adapter assembly is manufactured from a substantially transparent material.

In various embodiments, the present invention further provides a simplified shuttered fiber optic adapter assembly that includes an internally (and outwardly) opening shutter door that, when actuated, carries dust away from the interior of the adapter. Advantageously, this shutter door makes no contact with a connector that is inserted into the adapter. When the connector is inserted into the adapter, an outer housing slides upon an inner housing and the shutter door “flips” out of the way, nesting between the inner housing and the outer housing while the connector is held clear by tab structures manufactured into the outer housing. Once the shutter door has “flipped” out of the way and the outer housing has telescoped down the inner housing, these tab structures holding the connector clear are themselves “flexed” clear by the inner housing, allowing the connector to slide into the inner housing and connect to conventional fiber optic joining hardware. When the connector is removed from the adapter, it initiates the translation of the outer housing to its resting state. Optionally, a spring assists this translation and ensures that the outer housing reaches this resting state. Just prior to the end of travel of the outer housing, the shutter door, which is nested between the inner housing and the outer housing, is rotated into a closed configuration.

In one embodiment, the present invention provides a simplified shuttered fiber optic adapter assembly for optically coupling a plurality of optical fibers, including: an inner housing; an outer housing disposed at least partially around the inner housing, wherein the outer housing selectively telescopes along the inner housing from a first position to a second position; and a shutter door hingedly attached to the outer housing and in contact with the inner housing, wherein the shutter door is in a closed configuration when the outer housing is in the first position along the inner housing and in an open configuration when the outer housing is in the second position along the inner housing. The shutter door includes a pair of tab structures configured to contact a pair of slots and a plurality of pairs of stop structures manufactured into the inner housing. In the closed configuration, the shutter door covers an opening defined by the inner housing. In the open configuration, the shutter door is disposed substantially between the inner housing and the outer housing. The outer housing includes a pair of tab structures configured to engage a corresponding pair of recess structures manufactured into a connector that is selectively inserted into an interior portion of the outer housing.

It is to be understood that both the foregoing general description and the following detailed description provide exemplary embodiments of the present invention, and an overview or framework for understanding the nature and character of the present invention as it is claimed. The accompanying drawings are included in order to provide a further understanding of the present invention, and are incorporated into and constitute a part of this specification. The accompanying drawings illustrate the various exemplary embodiments of the present invention and, together with the detailed description, serve to explain the principles of operation thereof. The accompanying drawings are meant to be illustrative, and not limiting.

### BRIEF DESCRIPTION OF THE DRAWINGS

The present invention is illustrated and described herein with reference to the various drawings, in which like reference numbers are used to denote like assembly/mechanism components.

FIG. 1 is an exploded view of a conventional adapter including a pair of outer housings, a pair of inner housings, a sleeve, a retention clip, and a pair of dust caps, for a total of eight parts.

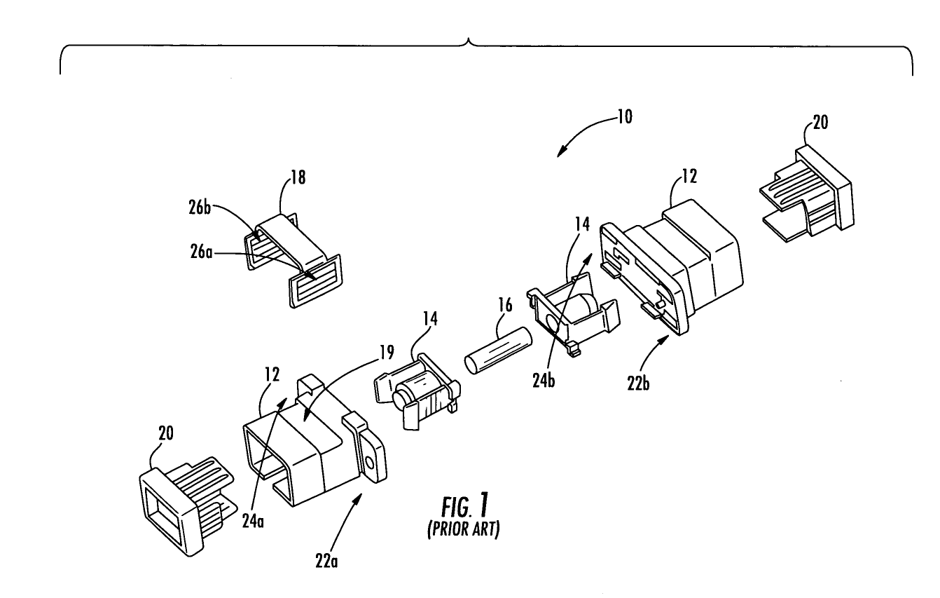

FIG. 2 is an exploded view of another conventional adapter including the pair of outer housings, the pair of inner housings, the sleeve, and the pair of dust caps, for a total of seven parts.

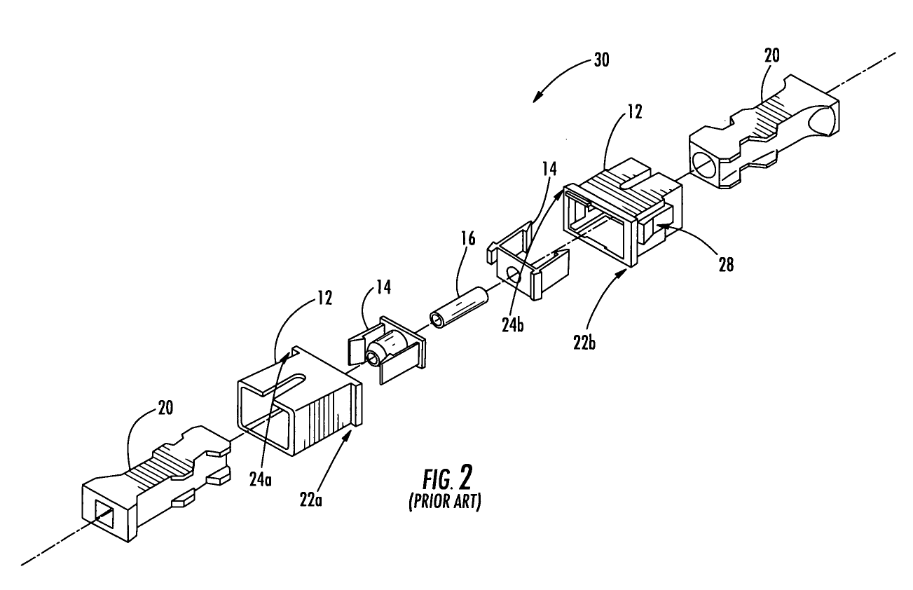

FIG. 3 is an exploded view of another conventional adapter including a pair of outer housings, an integrated/combination inner housing and sleeve assembly, the retention clip, and the pair of dust caps, for a total of six parts.

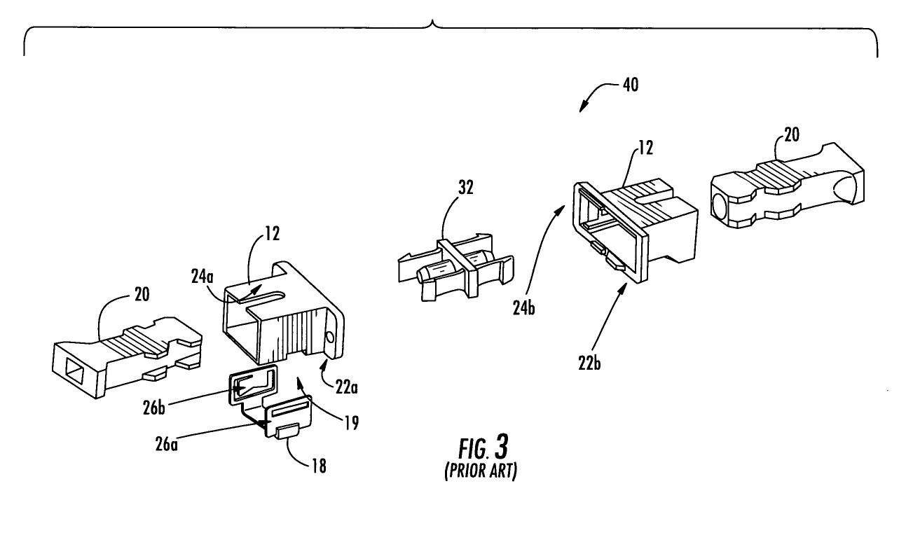

FIG. 4 is an exploded view of an adapter in accordance with an exemplary embodiment of the present invention.

FIG. 5 is a cutaway view of one embodiment of a one-piece outer housing, a one-piece inner housing, and a sleeve of FIG. 4, as assembled.

FIG. 6 is an exploded view of another adapter in accordance with another exemplary embodiment of the present invention.

FIG. 7 is a cutaway view of one embodiment of a one-piece outer housing, a two-piece inner housing, and a sleeve of FIG. 6, as assembled.

FIG. 8 is an exploded view of another adapter in accordance with another exemplary embodiment of the present invention.

FIG. 9 is a cutaway view of one embodiment of a one-piece outer housing, a two-piece inner housing, and a sleeve of FIG. 8, as assembled.

FIG. 10 is an exploded view of conventional shuttered SC adapter.

FIG. 11 is an exploded view of a shuttered adapter including an outer housing, inner housing, ferrule alignment sleeve, shutter doors, springs and connector alignment cap.

FIG. 12 is a perspective view illustrating the shuttered adapter of FIG. 11, as assembled.

FIG. 13 is a partial view of a shutter door connector latch mechanism of the present invention versus a conventional connector latch mechanism.

FIG. 14 is a cutaway view illustrating the shuttered adapter of FIGS. 11 and 12 with a connecter partially installed and the shutter doors partially deployed.

FIG. 15 is a cutaway view illustrating the shuttered adapter of FIGS. 11, 12, and 14 with a connecter, the shutter doors fully deployed and the shutter door connector latch mechanisms engaging and retaining the connector.

FIG. 16 is an exploded view of another embodiment of a shuttered adapter.

FIG. 17 is a perspective view illustrating the operation of the shuttered adapter of FIG. 16 with a connector not yet installed.

FIG. 18 is a perspective view illustrating the operation of the shuttered adapter of FIG. 16 with a connector installed.

FIG. 19 is a perspective view illustrating the operation of the shuttered adapter of FIG. 16 with a connector partially installed.

FIG. 20 is a perspective view illustrating the operation of the shutter door of the shuttered adapter of FIG. 16 with a connector partially installed.

### DETAILED DESCRIPTION OF THE INVENTION

In various embodiments, the present invention provides a simplified fiber optic adapter assembly that includes a one-piece outer housing, a one or two-piece inner housing, and several different clip arrangements, thereby reducing the number of parts associated with conventional fiber optic adapter assemblies and eliminating the need for ultrasonic welding or the like, thus resulting in decreased component costs, decreased labor requirements, decreased training requirements, and increased efficiencies.

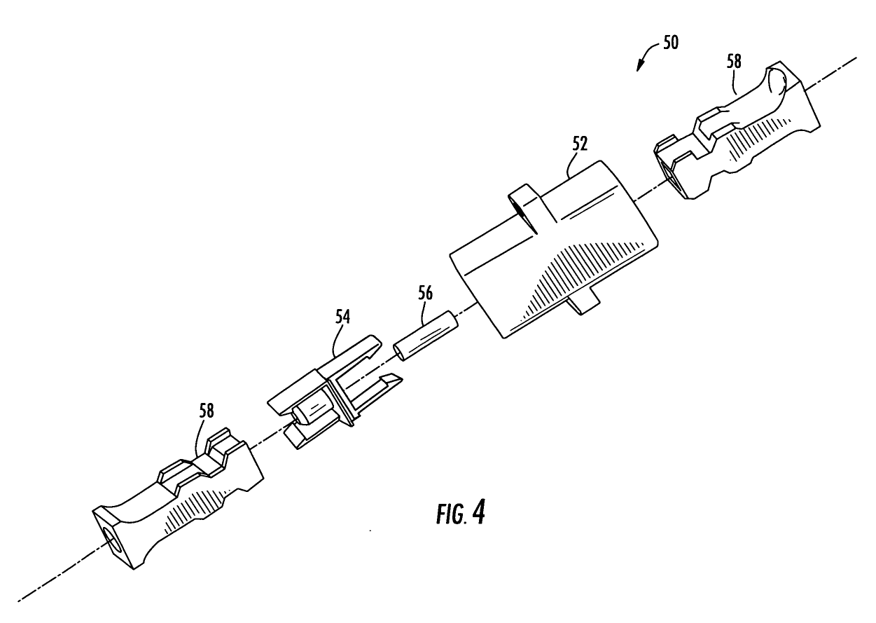

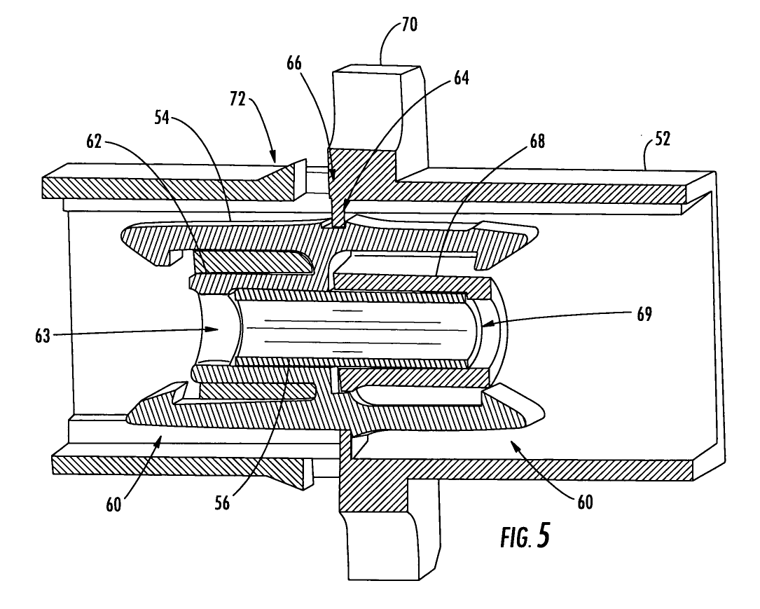

Referring to FIGS. 4 and 5, in one embodiment, the adapter 50 includes a one-piece outer housing 52, a one-piece inner housing 54, a sleeve 56, and a pair of dustcaps 58, for a total of five parts. The inner housing 54 includes two pairs of axially-aligned receiving arms 60 that are each configured to receive and retain a corresponding portion of a connector (not illustrated) when it is inserted into the outer housing 52. The inner housing 54 also includes a central portion that defines a sleeve bore 62 that is configured to selectively receive a portion of the sleeve 56, which may be ceramic or non-ceramic. The inner housing 54 further includes a pair of exterior molded clips 64 or ramp-and-recess structures that are configured to engage a pair of corresponding interior molded receivers 66 or protrusion structures that are manufactured into the outer housing 52. Thus, the inner housing 54 is selectively “snapped” into the outer housing 54, the sleeve 56 being captured by the sleeve bore 62 of the inner housing 54 and a similar sleeve bore 68 that is manufactured into the outer housing 54. These sleeve bores 62 and 68 are axially aligned and include ports 63 and 69 for access to the interior of the sleeve 56, which is also axially aligned. The outer housing 52 includes a pair of exterior tabs 70 or stop structures that selectively work in cooperation with a pair of retention tabs 72 or ramp-and-recess structures manufactured into opposing sides of the outer housing 52. When the adapter 50 is installed in a dividing member (not illustrated), the planar surface abuts the exterior tabs 70 of the outer housing 52 on one side and the retention tabs 72 of the outer housing 52 on the other side. Thus, the outer housing 52 is selectively “snapped” into the dividing member. The dust caps 58 are selectively disposed within each end of the adapter 50 in order to prevent the intrusion of particulate matter into the interior of the adapter 50 when the connectors are not engaged. Advantageously, the components of the adapter 50 may comprise injection molded plastic or the like, and no ultrasonic welding or the like is required to assemble the adapter 50.

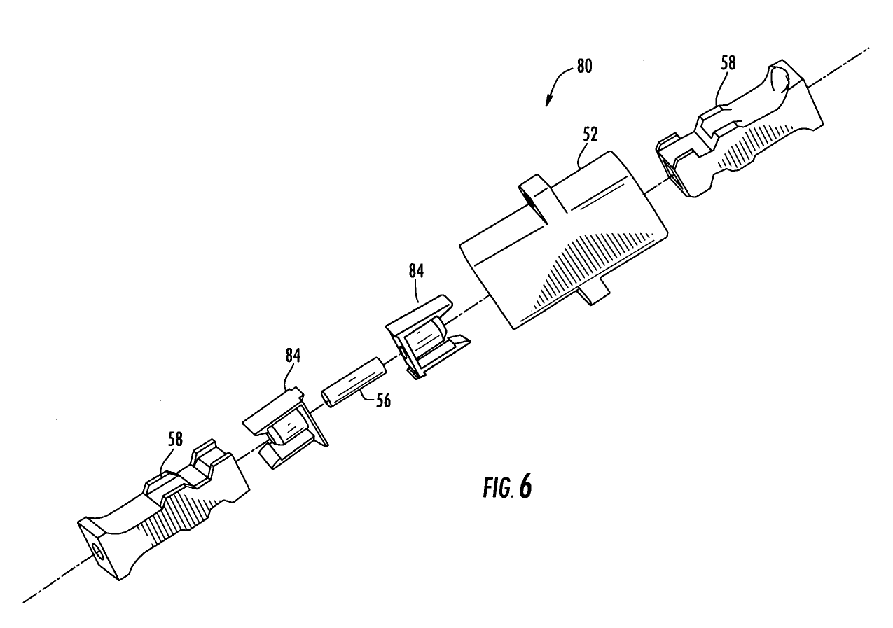

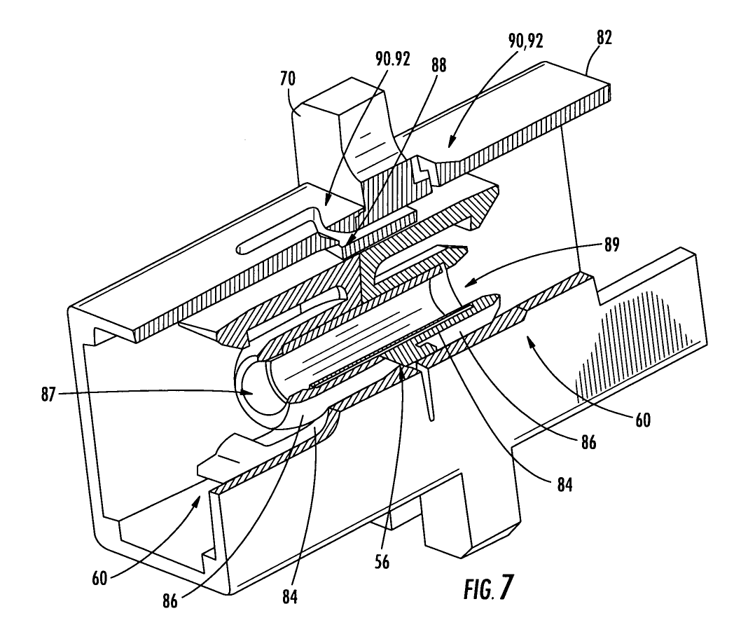

Referring to FIGS. 6 and 7, in another embodiment, the adapter 80 includes a one-piece outer housing 82, a two-piece inner housing 84, the sleeve 56, and the pair of dust caps 58, for a total of six parts. The inner housings 84 each include a pair of axially-aligned receiving arms 60 that are configured to receive and retain a corresponding portion of a connector (not illustrated) when it is inserted into the outer housing 82. The inner housings 84 each also include a central portion that defines a sleeve bore 86 that is configured to selectively receive a portion of the sleeve 56, which may be ceramic or non-ceramic. The inner housings 84 each further include a pair of exterior molded tabs 88 or fin structures that are configured to engage a pair of corresponding flexible clips 90 or clip-and-stop structures that are manufactured into or fixed to the interior of the outer housing 82. Thus, the inner housings 84 are selectively “snapped” into the outer housing 82, the sleeve 56 being captured by the sleeve bores 86 of the inner housings 84. These sleeve bores 86 are axially aligned and include ports 87 and 89 for access to the interior of the sleeve 56, which is also axially aligned. Optionally, the outer housing 82 includes a pair of exterior tabs 70 or stop structures that selectively work in cooperation with a pair of retention tabs 92 or ramp-and-recess structures manufactured into opposing sides of the outer housing 82. When the adapter 80 is installed in a dividing member (not illustrated), the planar surface abuts the exterior tabs 70 of the outer housing 82 on one side and the retention tabs 92 of the outer housing 82 on the other side. Thus, the outer housing 82 is selectively “snapped” into the dividing member. The dust caps 58 are selectively disposed within each end of the adapter 80 in order to prevent the intrusion of particulate matter into the interior of the adapter 80 when the connectors are not engaged. Advantageously, the components of the adapter 80 may comprise injection molded plastic or the like, and no ultrasonic welding or the like is required to assemble the adapter 80.

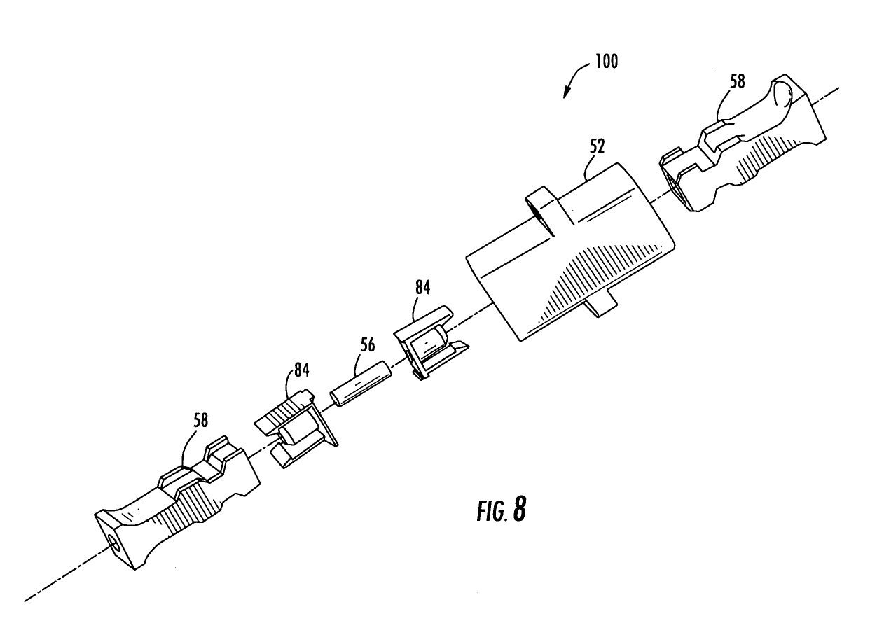

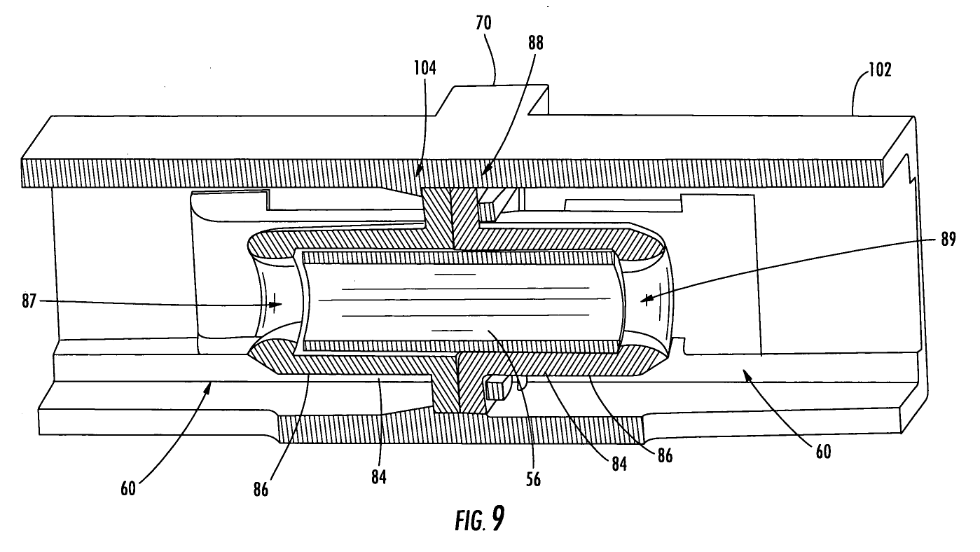

Referring to FIGS. 8 and 9, in a further embodiment, the adapter 100 includes a one-piece outer housing 102, the two-piece inner housing 84, the sleeve 56, and the pair of dust caps 58, for a total of six parts. The inner housings 84 each include a pair of axially-aligned receiving arms 60 that are configured to receive and retain a corresponding portion of a connector (not illustrated) when it is inserted into the outer housing 102. The inner housings 84 each also include a central portion that defines a sleeve bore 86 that is configured to selectively receive a portion of the sleeve 56, which may be ceramic or non-ceramic. The inner housings 84 each further include a pair of exterior molded tabs 88 or fin structures that are configured to engage a pair of corresponding inflexible clips 104 or clip-and-stop structures that are manufactured into or fixed to the interior of the outer housing 102. Thus, the inner housings 84 are selectively “snapped” into the outer housing 102, the sleeve 56 being captured by the sleeve bores 86 of the inner housings 84. These sleeve bores 86 are axially aligned and include ports 87 and 89 for access to the interior of the sleeve 56, which is also axially aligned. Optionally, the outer housing 102 includes a pair of exterior tabs 70 or stop structures that selectively work in cooperation with a pair of retention tabs (not illustrated) or ramp-and-recess structures manufactured into opposing sides of the outer housing 102. When the adapter 100 is installed in a dividing member (not illustrated), the planar surface abuts the exterior tabs 70 of the outer housing 102 on one side and the retention tabs of the outer housing 102 on the other side. Thus, the outer housing 102 is selectively “snapped” into the dividing member. The dust caps 58 are selectively disposed within each end of the adapter 100 in order to prevent the intrusion of particulate matter into the interior of the adapter 100 when the connectors are not engaged. Advantageously, the components of the adapter 100 may comprise injection molded plastic or the like, and no ultrasonic welding or the like is required to assemble the adapter 100.

In various embodiments, the present invention also provides a simplified shuttered fiber optic adapter assembly that includes internally opening shutter doors that, when actuated, act as latches for engaging and securing a conventional mating connector. The motion of these shutter doors is initiated by the insertion of the connector. The geometry and orientation of the shutter doors is such that the ferrule of the connector does not make contact with the shutter doors, thus avoiding contamination of the ferrule. The latching geometry utilized retains the connector within the adapter, while maintaining the clearance necessary for the motion of the shutter doors, without significantly and undesirably increasing the overall dimensions of the adapter. For example, the adapter of the present invention does not have to be lengthened relative to a conventional adapter in order to accommodate the motion of the shutter doors. Again, such dimensional increase negatively impacts the density of grouped adapters. Optionally, the shutter doors are manufactured from a translucent material in order to incorporate VFL capability, for example, enabling the operator/installer to easily determine if the adapter is receiving a signal. Again, “snap-fit’ assembly is provided, eliminating the need for ultrasonic welding or the like.

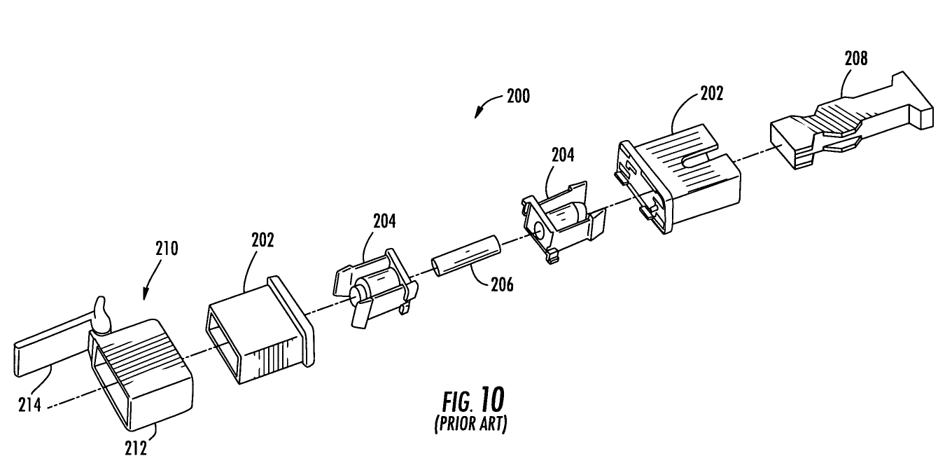

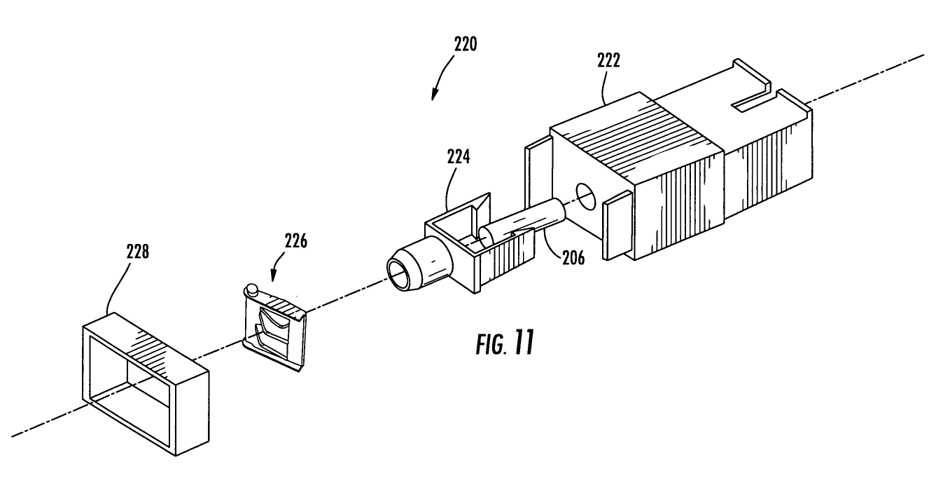

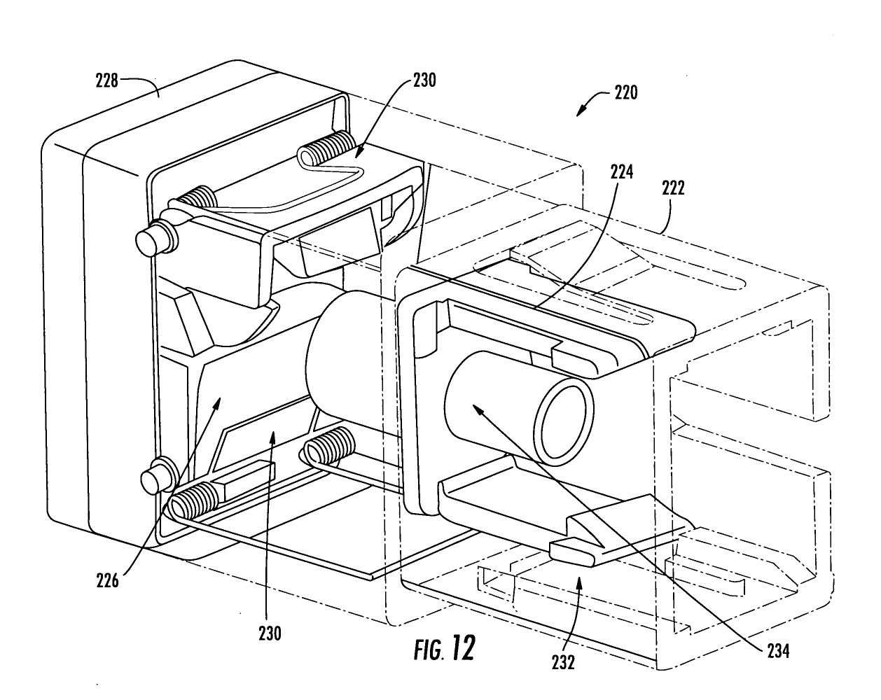

Referring to FIGS. 10 and 11, one type of conventional shuttered SC adapter 200 includes a pair of outer housings 202, a pair of inner housings 204, a ferrule alignment sleeve 206, a dustcap 208, and an add-on spring-loaded shutter door assembly 210 (including a fixed or removable alignment cap 212, a shutter door 214, and one or more springs (not illustrated)). The shuttered adapter 220 of the present invention (also shown in an SC configuration), however, includes a one-piece outer housing 222, a one-piece inner housing 224, the ferrule alignment sleeve 206, a pair of shutter doors 226, a pair of springs 230 (FIG. 12), and a connector alignment cap 228.

Referring to FIG. 12, in one embodiment, the shuttered adapter 220 includes the one-piece outer housing 222, the one-piece inner housing 224, the ferrule alignment sleeve 206 (FIG. 11), the pair of shutter doors 226, the pair of springs 230, and the connector alignment cap 228. The inner housing 224 includes a pair of axially-aligned receiving arms 232 that are configured to receive and retain a corresponding portion of a connector (not illustrated) when it is inserted into the outer housing 222. The inner housing 224 also includes a central portion that defines a ferrule alignment sleeve bore 234 that is configured to selectively receive a portion of the ferrule alignment sleeve 206 (FIG. 11), which may be ceramic or non-ceramic. The inner housing 224 is selectively “snapped” into the outer housing 222. The ferrule alignment sleeve bore 234 is axially aligned for access to the interior of the ferrule alignment sleeve 206 (FIG. 11), which is also axially aligned. The outer housing 222 is selectively “snapped” into a dividing member or the like. The springs 230 are assembled inside the outer housing 222 and provide the shutter doors 226, assembled at one opening of the outer housing 222, with a bias force. The connector alignment cap 228 is also installed at this opening of the outer housing 222, thereby pivotably locking the shutter doors 226 in place. Advantageously, the components of the shuttered adapter 220 may comprise injection molded plastic or the like, and no ultrasonic welding or the like is required to assemble the shuttered adapter 220.

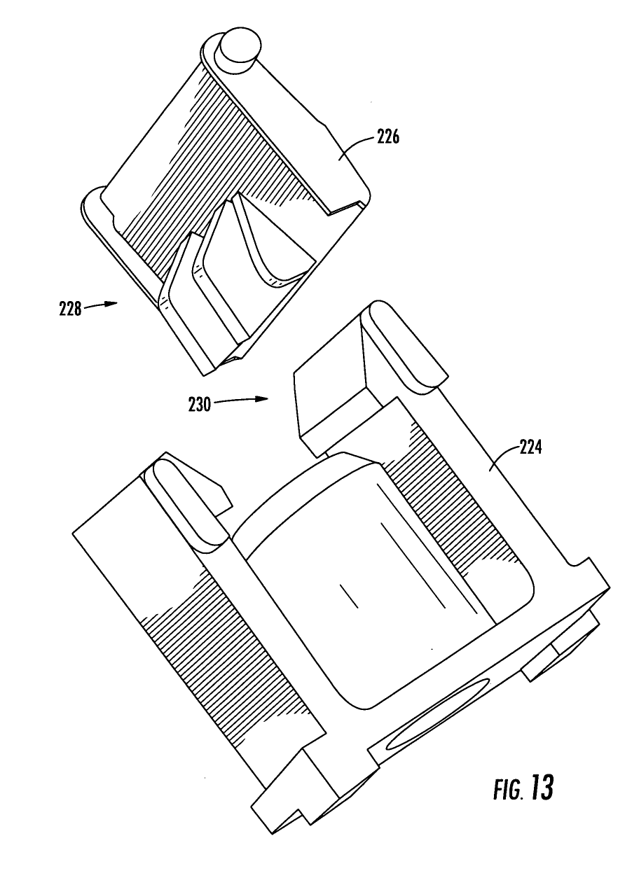

Referring to FIG. 13, the shutter door connector latch mechanism 228 of the shuttered adapter 220 (FIGS. 11 and 12) of the present invention is functionally equivalent to the conventional connector latch mechanism 230 of a conventional SC inner housing or the inner housing 224 of the shuttered adapter 220 (FIGS. 11 and 12) of the present invention, for example. The geometry and orientation of the shutter doors 226, and specifically the shutter door connector latch mechanisms 228, is such that the ferrule (not illustrated) of the connector (not illustrated) does not make contact with the shutter doors 226, thus avoiding contamination of the ferrule (not illustrated). Preferably, the edge of each of the shutter doors 226 is tapered or “bull-nosed,” so as to provide a tight seal from dust and light.

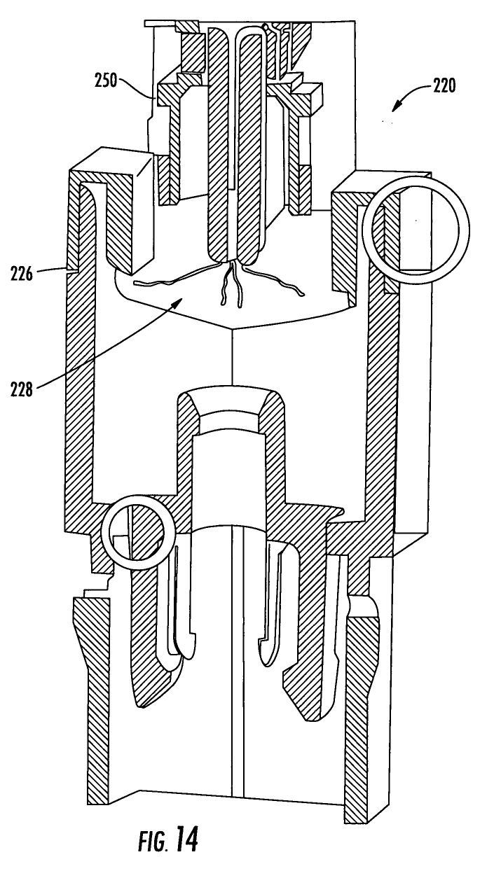

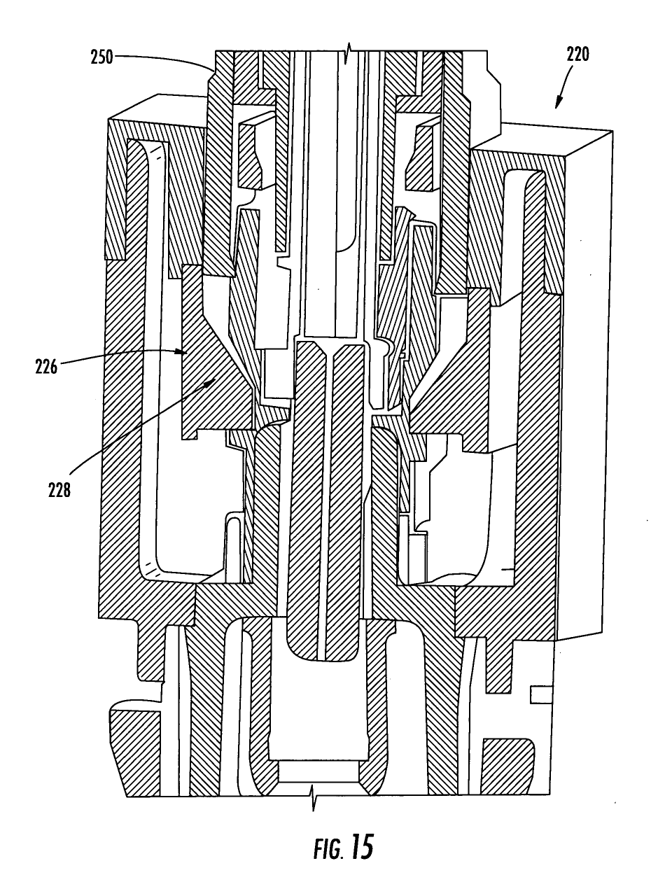

FIG. 14 is a cutaway perspective view illustrating the shuttered adapter 220 of FIGS. 11 and 12 with a connecter 250 partially installed, the shutter doors 226 partially deployed. FIG. 15 is a cutaway perspective view illustrating the shuttered adapter 220 of FIGS. 11, 12, and 14 with a connecter 250 fully installed, the shutter doors 226 fully deployed and the shutter door connector latch mechanisms 228 engaging and retaining the connector.

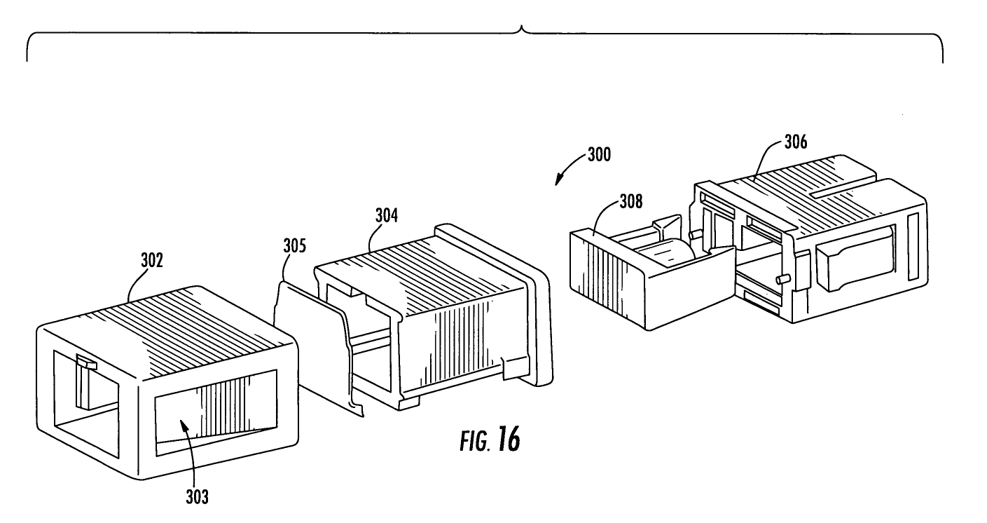

In various embodiments, and specifically referring to the embodiment illustrated in FIG. 16, the present invention further provides a simplified shuttered fiber optic adapter assembly 300 that includes an internally (and outwardly) opening shutter door 305 that, when actuated, carries dust away from the interior of the adapter 300. Advantageously, this shutter door 305 makes no contact with a connector (not illustrated) that is inserted into the adapter 300. When the connector (not illustrated) is inserted into the adapter 300, an outer housing 302 slides upon an inner housing 304 and the shutter door 305 “flips” out of the way, nesting between the inner housing 304 and the outer housing 302 while the connector (not illustrated) is held clear by tab structures 303 manufactured into the outer housing 302. Once the shutter door 305 has “flipped” out of the way and the outer housing 302 has telescoped down the inner housing 304, these tab structures 303 holding the connector (not illustrated) clear are themselves “flexed” clear by the inner housing 304, allowing the connector (not illustrated) to slide into the inner housing 304 and connect to conventional fiber optic joining hardware, consisting of a conventional adapter outer body/housing 306 or the like, a conventional adapter inner body/housing 306 or the like, and a conventional ferrule alignment sleeve (not illustrated) or the like, described in detail above. This conventional fiber optic joining hardware is ultrasonically welded to the inner housing 304, for example. When the connector (not illustrated) is removed from the adapter 300, it initiates the translation of the outer housing 302 to its resting state. Optionally, a spring (not illustrated) assists this translation and ensures that the outer housing 302 reaches this resting state. Just prior to the end of travel of the outer housing 302, the shutter door 305, which is nested between the inner housing 304 and the outer housing 302, is rotated into a closed configuration.

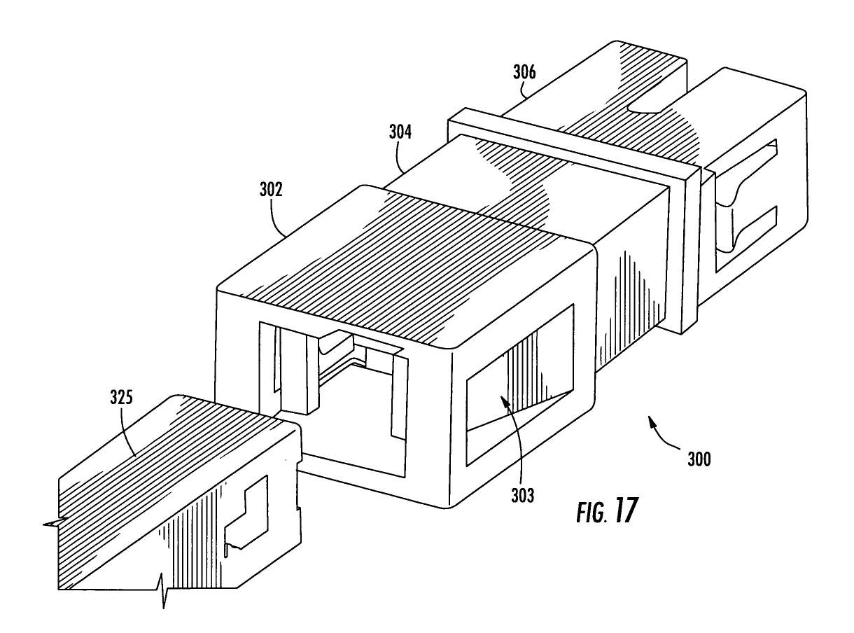

FIG. 17 is a perspective view illustrating the operation of the shuttered adapter 300 of FIG. 16, a connector 325 not yet installed. In this configuration, the outer housing 302 is fully extended, exposing the inner housing 304, and the shutter door 305 (FIG. 16) is closed.

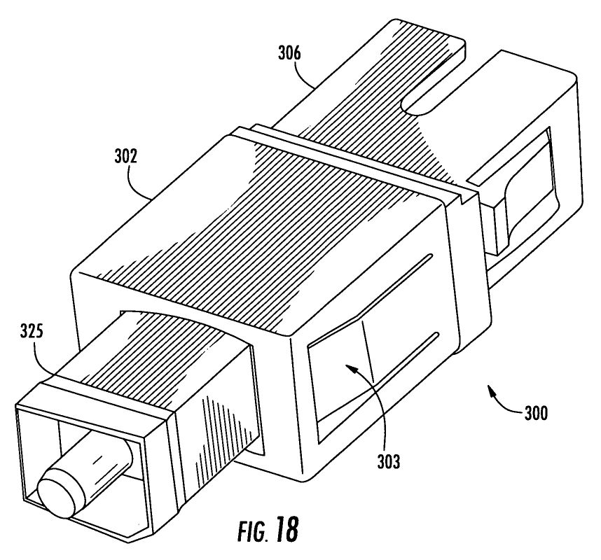

FIG. 18 is a perspective view illustrating the operation of the shuttered adapter 300 of FIG. 16, the connector 325 fully installed. In this configuration, the outer housing 302 is fully collapsed, hiding the inner housing 304 (FIGS. 16 and 17), and the shutter door 305 (FIG. 16) is nested between the inner housing 304 (FIGS. 16 and 17) and the outer housing 302. It should be noted that the tab structures 303 of the outer housing 302 are fully “flexed” outboard and are resting upon the inner housing 304 (FIGS. 16 and 17).

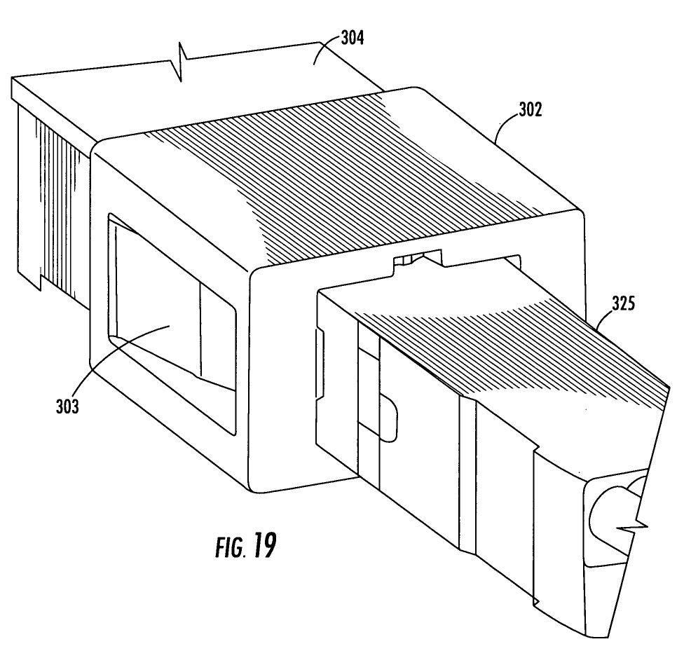

FIG. 19 is a perspective view illustrating the operation of the shuttered adapter 300 of FIG. 16, the connector 325 partially installed. In this configuration, the connector 325 slides freely into the opening associated with the outer housing 302, but is stopped from translating further into the outer housing 302 by the tab structures 303 of the outer housing 302. Further pressure causes the connector 325 and the outer housing 302 to translate as a unit upon the inner housing 304, causing the shutter door 305 (FIG. 16) to open. With the shutter door 305 (FIG. 16) open and clear of the connector 325, further pressure causes the inner housing 304 to force the tab structures 303 of the outer housing 302 outwards, “flexing” them outboard. When the connector 325 is no longer constrained by the tab structures 303, it is allowed to travel freely into the inner housing 304 and engage the conventional fiber optic joining hardware.

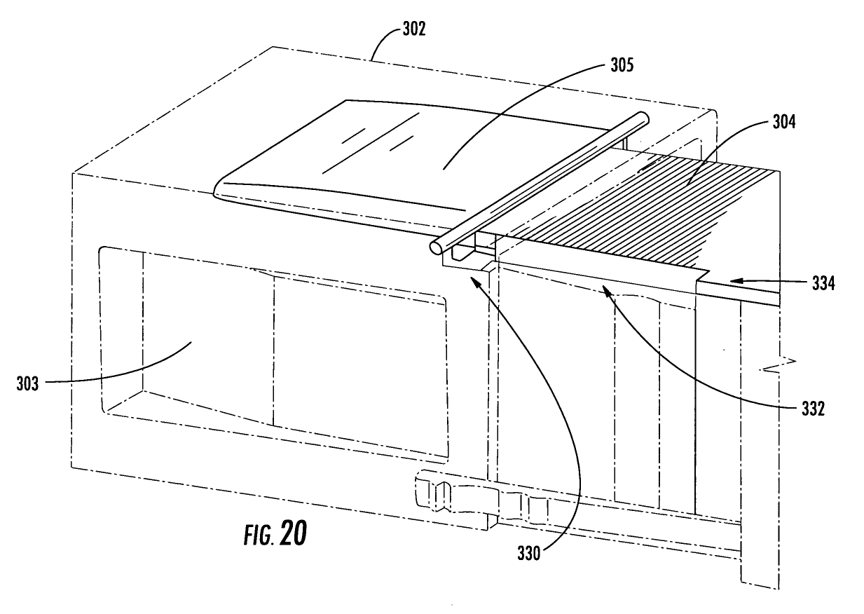

FIG. 20 is a perspective view illustrating the operation of the shutter door 305 of the shuttered adapter 300 of FIG. 16, the connector 325 (FIGS. 17-19) partially installed. The shutter door 305 is hinged to the outer housing 302 and its orientation is determined by its interaction with the inner housing 304. As the connector 325 (FIGS. 17-19) and the outer housing 302 telescope along the inner housing 304, the inner housing 304 presses on the inside surface of the shutter door 305, which rotates 90 degrees until it is clear of the inner housing 304 and nests between the inner housing 304 and the outer housing 302. Optionally, tab structures 330 on the shutter door 305 slide in slots 332 manufactured into the inner housing 304, encountering stop structures 334 at both ends of the slots 332.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An adapter assembly, comprising:
an outer housing, the outer housing having an interior portion comprising a retention structure, wherein the retention structure is one of integrally formed with the outer housing and fixedly attached to the outer housing;
an inner housing selectively disposed within the interior portion of the outer housing, the inner housing having an exterior portion comprising a corresponding retention structure, wherein the corresponding retention structure is one of integrally formed with the inner housing and fixedly attached to the inner housing, the inner housing further having an interior portion defining a bore; and
a sleeve at least partially disposed within the bore defined by the interior portion of the inner housing.

2. The adapter assembly of claim 1, the outer housing further having an exterior portion comprising at least one tab structure configured to abut a planar surface through which the outer housing is disposed.

3. The adapter assembly of claim 1, the outer housing further having an exterior portion comprising at least one ramp structure configured to abut a planar surface through which the outer housing is disposed.

4. The adapter assembly of claim 1, wherein the inner housing comprises a one-piece inner housing.

5. The adapter assembly of claim 1, wherein the inner housing comprises a two-piece inner housing.

6. The adapter assembly of claim 1, wherein the retention structure of the outer housing comprises a protruding structure and the corresponding retention structure of the inner housing comprises a recessed structure that is configured to selectively receive the protruding structure.

7. The adapter assembly of claim 1, wherein the retention structure of the outer housing comprises a substantially flexible protruding structure and a stop structure and the corresponding retention structure of the inner housing comprises a tab structure that is configured to be selectively disposed between the substantially flexible protruding structure and the stop structure.

8. The adapter assembly of claim 1, wherein the retention structure of the outer housing comprises a substantially inflexible protruding structure and a stop structure and the corresponding retention structure of the inner housing comprises a tab structure that is configured to be selectively disposed between the substantially inflexible protruding structure and the stop structure.

9. The adapter assembly of claim 1, wherein the adapter assembly is free from any ultrasonic or other welds.

10. An adapter assembly, comprising:
an outer housing, the outer housing having an interior portion comprising a retention structure, wherein the retention structure is integrally formed with the outer housing;
a one-piece inner housing selectively disposed within the interior portion of the outer housing, the one-piece inner housing having an exterior portion comprising a corresponding retention structure, wherein the corresponding retention structure is integrally formed with the one-piece inner housing and, the one-piece inner housing further having an interior portion defining a bore; and
a sleeve at least partially disposed within the bore defined by the interior portion of the one-piece inner housing.

11. The adapter assembly of claim 11, wherein the interior portion of the outer housing defines a corresponding bore within which the sleeve is at least partially disposed.

12. The adapter assembly of claim 11, the outer housing further having an exterior portion comprising at least one tab structure configured to abut a planar surface through which the outer housing is disposed.

13. The adapter assembly of claim 11, the outer housing further having an exterior portion comprising at least one ramp structure configured to abut a planar surface through which the outer housing is disposed.

14. An adapter assembly, comprising:
an outer housing, one end of the outer housing defining an opening; and
a pair of shutter doors disposed at the opening defined by the outer housing, each of the pair of shutter doors comprising a shutter door connector latch mechanism configured to engage and retain a connector that is inserted through the pair of shutter doors, through the opening defined by the outer housing, and into the outer housing.

15. The adapter assembly of claim 14, further comprising a connector alignment cap disposed at the opening defined by the outer housing, the connector alignment cap configured to hingedly secure the pair of shutter doors at the opening defined by the outer housing.

16. The adapter assembly of claim 14, further comprising one or more springs disposed at least partially adjacent to the pair of shutter doors, the one or more springs operable for biasing the pair of shutter doors in a closed configuration.

17. The adapter assembly of claim 14, wherein at least a portion of the shuttered adapter assembly is manufactured from a substantially transparent material.

18. An adapter assembly, comprising:
an inner housing;
an outer housing disposed at least partially around the inner housing, wherein the outer housing selectively telescopes along the inner housing from a first position to a second position; and
a shutter door hingedly attached to the outer housing and in contact with the inner housing, wherein the shutter door is in a closed configuration when the outer housing is in the first position along the inner housing and in an open configuration when the outer housing is in the second position along the inner housing.

19. The adapter assembly of claim 18, wherein the shutter door comprises a pair of tab structures configured to contact a pair of slots and a plurality of pairs of stop structures manufactured into the inner housing.

20. The adapter assembly of claim 18, wherein, in the closed configuration, the shutter door covers an opening defined by the inner housing.

21. The adapter assembly of claim 18, wherein, in the open configuration, the shutter door is disposed substantially between the inner housing and the outer housing.

22. The adapter assembly of claim 18, wherein the outer housing comprises a pair of tab structures configured to engage a corresponding pair of recess structures manufactured into a connector that is selectively inserted into an interior portion of the outer housing.
